(19) United States
(12) Patent Application Publication
(10) Pub. No.: US 2015/0037637 A1
(43) Pub. Date: Feb. 5, 2015

(54) RECHARGEABLE BATTERY

(71) Applicant: SAMSUNG SDI CO., LTD., Yongin-si (KR)

(72) Inventor: Jong-Seok MUN, Yongin-si (KR)

(73) Assignee: SAMSUNG SDI CO., LTD., Yongin-si (KR)

(21) Appl. No.: 14/210,635

(22) Filed: Mar. 14, 2014

(30) Foreign Application Priority Data
Jul. 31, 2013 (KR) 10-2013-0091089

(51) Int. Cl. H01M 10/04

(52) U.S. Cl. CPC H01M 10/0431
USPC 429/94

(57) ABSTRACT

A rechargeable battery includes an electrode assembly including spiral-wound a first electrode, a first separator, second electrode, and a second separator, the first electrode, first separator, second electrode, and second separator being sequentially disposed around a center, a case receiving the electrode assembly, and a cap assembly coupled to an opening of the case, wherein the first separator and the second separator enclose first ends of the first electrode and the second electrode at the center, portions of the first and second separators defining a re-spiral-wound region having at least a first portion disposed between the first electrode and the second electrode in a diameter direction of the electrode assembly.

### CROSS-REFERENCE TO RELATED APPLICATION

Korean Patent Application No. 10-2013-0091089, filed on Jul. 31, 2013, in the Korean Intellectual Property Office, and entitled: “Rechargeable Battery,” is incorporated by reference herein in its entirety.

### BACKGROUND

1. Field

The described technology relates generally to a rechargeable battery of a method cutting an electrode that an active material is coated to a current collector.

2. Description of the Related Art

As technical developments and demands on mobile devices have increased, demands on rechargeable batteries as an energy source have also increased. For example, a cylindrical rechargeable battery may include an electrode assembly formed by disposing electrodes on both sides of a separator and spirally winding the same in a jellyroll form, a case containing the electrode assembly, and a cap assembly for closing and sealing an opening on one side of the case.

In the electrode assembly, the electrode includes a coated region (a composite region) formed by coating an active material (a composite slurry) on a current collector and an uncoated region established by exposing the current collector at an end of the coated region, and the uncoated region is provided at both ends of the electrode assembly in a width direction. As one example, the uncoated region is provided at both ends of the electrode assembly in a width direction, is connected to the case through the negative current collecting plate, and is connected to the cap assembly through the positive current collecting plate and the lead tab.

In a cylindrical rechargeable battery having a limited volume, a positive active material determines a cell capacitance. Accordingly, to have high-capacity, it is required that the positive active material is increased to the maximum. However, as one example of the positive electrode, the uncoated region in which the active material is not provided at both surfaces of the current collector is provided at both ends of the current collector. In this case, one uncoated region is connected to the lead tab, however the other uncoated region does not contribute to the cell capacity and occupies an inner space of the cell. That is, the uncoated region decreases the capacity in the rechargeable battery of the limited volume.

### SUMMARY

Example embodiments provide a rechargeable battery in which damage to a separator caused by a thickness of a coating region and a burr formed at an end of a current collector is prevented in a method of cutting an electrode in which an active material is coated on the current collector.

A rechargeable battery according to an exemplary embodiment includes an electrode assembly including spiral-wound a first electrode, a first separator, second electrode, and a second separator, the first electrode, first separator, second electrode, and second separator being sequentially disposed around a center, a case receiving the electrode assembly, and a cap assembly coupled to an opening of the case, wherein the first separator and the second separator enclose first ends of the first electrode and the second electrode at the center, portions of the first and second separators defining a re-spiral-wound region having at least a first portion disposed between the first electrode and the second electrode in a diameter direction of the electrode assembly.

The re-spiral-wound region may have a predetermined range in a spiral-wound direction.

The re-spiral-wound region and the second separator that is spiral-wound at least a predetermined number of times may be triply disposed between the end of the second electrode and the first electrode that is spiral-wound a predetermined number of times in the diameter direction.

The end of the first electrode and the end of the second electrode may maintain a first distance according to the spiral-wound direction, and the end of the second electrode and the end of the re-spiral-wound region may maintain a second distance according to the spiral-wound direction.

The entire length of the re-spiral-wound region may be set to be larger than a length of the first separator and the second separator between a start point of the re-spiral-wound region and the end of the second electrode in the spiral-wound direction.

The entire length of the re-spiral-wound region may be larger than the length of the predetermined number of spiral-wound times of the first electrode, and may be smaller than the length of (n+1) spiral-wound times of the first electrode.

The first separator may be provided inside between the end of the second electrode and the first electrode inside in the diameter direction, and the second separator and the re-spiral-wound region may be provided outside between the end of the second electrode and the first electrode that is spiral-wound the predetermine number of times.

The first electrode may have an uncoated region at an outermost end thereof, and the second electrode may have the uncoated region between both ends thereof.

The uncoated region of the first electrode may be connected to the case by a first lead tab, and the uncoated region of the second electrode may be connected to the cap assembly by a second lead tab.

### BRIEF DESCRIPTION OF THE DRAWINGS

Features will become apparent to those of ordinary skill in the art by describing in detail exemplary embodiments with reference to the attached drawings, in which:

FIG. 1 illustrates a cross-sectional view of a rechargeable battery according to an exemplary embodiment.

FIG. 2A illustrates a cross-sectional unwound view of a portion of the electrode assembly of FIG. 1.

FIG. 2B illustrates an enlarged portion of FIG. 2A;

FIG. 3 illustrates a state diagram of an electrode material and a separator supplied to a mandrel manufacturing the electrode assembly of FIG. 1.

FIG. 4 illustrates a re-spiral-wound start state diagram of a separator re-spiral-wound region, following FIG. 3.

FIG. 5 illustrates a spiral-wound state diagram of a separator re-spiral-wound region, an electrode material, and a separator, following FIG. 4.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

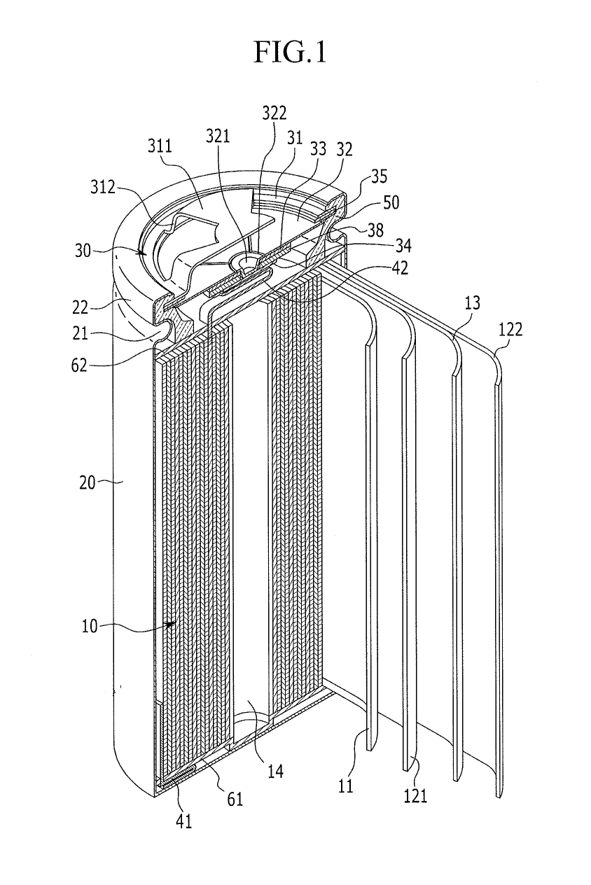

FIG. 1 illustrates a cross-sectional view of a rechargeable battery according to an exemplary embodiment. Referring to FIG. 1, a rechargeable battery according to the first exemplary embodiment may include an electrode assembly 10 performing charging and discharging operations, a case 20 enclosing the electrode assembly 10 therein, and a cap assembly 30 coupled to an opening of the case 20. The cap assembly 30 is coupled to the opening of the case 20 by interposing a gasket 50 to be insulated from the case 20, and closes and seals the case 20 receiving the electrode assembly 10 and an electrolyte solution.

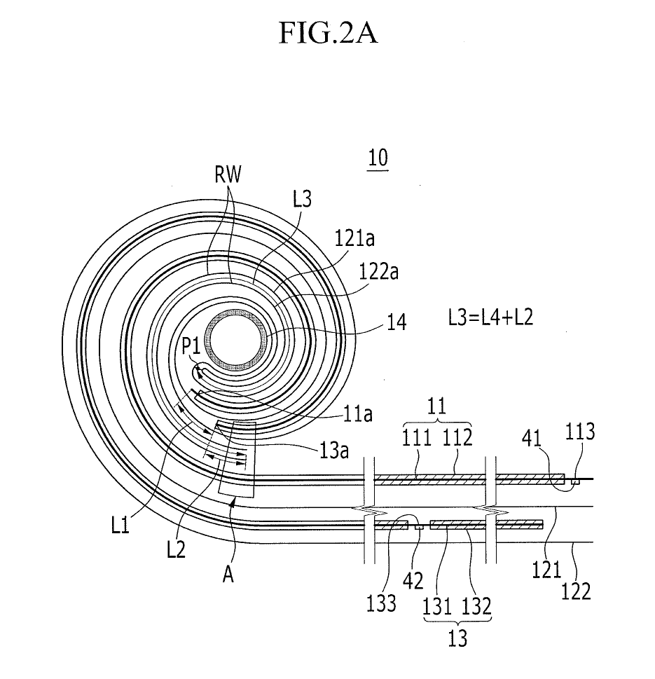

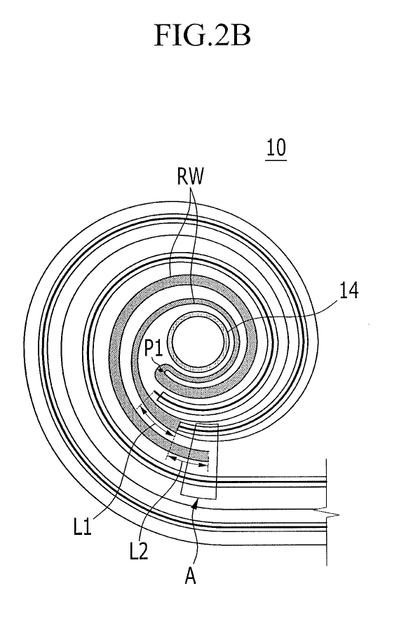

FIG. 2A illustrates a cross-sectional unwound view of a portion of the electrode assembly of FIG. 1. Referring to FIG. 1 and FIG. 2A, the electrode assembly 10 includes a first electrode 11 (for example, a negative electrode), a first separator 121, a second electrode 13 (for example, a positive electrode), and a second separator 122 that are sequentially deposited and disposed. The electrode assembly 10 is formed by spiral-winding the negative electrode 11, the positive electrode 13, and the first and second separators 121 and 122 interposed therebetween as an insulating material in a jellyroll form.

For example, the electrode assembly 10 may be formed in a cylindrical shape. The cylindrical electrode assembly 10 may include a center pin 14 at the center. The center pin 14 maintains the electrode assembly 10 in the cylinder shape.

The negative electrode 11 includes coated regions 112 where an active material is coated to both sides of a current collector 111 that is formed of a thin metal plate, and uncoated regions 113 where the active material is not coated and is formed of the exposed current collector. For example, the current collector 111 of the negative electrode 11 may be made of copper.

The uncoated region 113 is set to the first end disposed at the center of the electrode assembly 10 and the second end disposed outermost in the current collector 111. For example, the first end is disposed at the center in the electrode assembly 10 that is completely spiral-wound, and the second end is disposed outermost of the electrode assembly 10. A negative electrode lead tab 41 is connected to the outermost uncoated region 113.

The positive electrode 13 includes coated regions 132 where the active material is coated to both sides of a current collector 131 that is formed of the thin metal plate, and uncoated regions 133 where the active material is not coated and are formed of the exposed current collector 131. For example, the current collector 131 of the positive electrode 13 may be formed of aluminum.

The uncoated region 133 is provided between the first end disposed at the center of the electrode assembly 10 in the current collector 131 and the second end disposed outermost. For example, the first end is disposed at the center of the electrode assembly 10 that is completely spiral-wound, and the second end is disposed outermost of the electrode assembly 10. A positive electrode lead tab 42 is connected to the uncoated region 133 between the first end and the second end.

In the jellyroll state, a negative electrode insulating plate 61 may be interposed between the electrode assembly 10 and the case 20 to be electrically insulated. The negative electrode lead tab 41 is welded to the uncoated region 113 of the negative electrode 11 provided outermost (or at the center) of the electrode assembly 10 while passing through negative electrode insulating plate 61, and is connected to a bottom inner surface of the case 20 by welding. Accordingly, the case 20 acts as the negative terminal in the rechargeable battery.

The case 20 forms an opening in one side thereof for insertion of the electrode assembly 10 from the outside, is formed in the shape of a cylinder to receive the cylindrical electrode assembly 10, and may be formed of a conductive metal, e.g., aluminum, an aluminum alloy, or nickel.

A positive electrode insulating plate 62 may be interposed between the cap assembly 30 and the electrode assembly 10 to be insulated therebetween. The positive electrode lead tab 42 is connected to the uncoated region 133 of the positive current collector 131 by welding, and is electrically connected to the cap assembly 30 through a positive electrode insulating plate 62. Accordingly, the cap assembly 30 acts as the positive electrode terminal in the rechargeable battery.

For example, the cap assembly 30 includes a cap plate 31, a positive temperature coefficient (PTC) element 35, a vent plate 32, an insulation member 33, a middle plate 38, and a sub-plate 34, which are sequentially arranged toward the inside of the case 20 from the outside thereof.

The cap plate 31 is connected to the positive electrode lead tab 42 through a current blocking device and, thus, functions as the positive terminal in the rechargeable battery. The cap plate 31 includes a protrusion 311 protruding to the outside of the case 20 and an exhaust pipe 312 open at a side of the protrusion 311 to exhaust internal gas.

The current blocking device includes the vent plate 32, the sub-plate 34, and a connector thereof in the cap assembly 30. The connector is formed by connecting the vent plate 32 and the sub-plate 34 through welding.

The vent plate 32 forming one side of the current blocking device is installed at an inner side of the cap plate 31, and is thus electrically connected to the sub-plate 34 that forms the other side of the current blocking device.

In addition, the vent plate 32 includes a vent 321 which is ruptured under a predetermined pressure condition to discharge the internal gas to the outside and block the electrical connection with the sub-plate 34. For example, the vent 321 protrudes toward an inner side of the case 20 from the vent plate 32. The vent plate 32 is provided with a notch 322 that guides rupture of the vent 321 in the peripheral area of the vent 321. Thus, when internal pressure of the case 20 is increased due to generation of gas, the notch 322 is ruptured in advance to discharge the gas to the outside through the vent plate 32 and the exhaust hole 312 to thereby prevent explosion of the rechargeable battery cell. In this case, when the connection portion of the vent plate 32 and the sub-plate 34 is separated due to the rupture of the vent 321, the electrode assembly 10 and the cap plate 31 are electrically separated from each other.

The PTC element 35 is provided between the cap plate 31 and the vent plate 32 to control a current flow between the cap plate 31 and the vent plate 32 according to an internal temperature of the rechargeable battery. When the internal temperature exceeds a predetermined temperature, electrical resistance of the PTC element 35 increases to infinity. Accordingly, the PTC element 35 can block a charging current or a discharging current between the cap plate 31 and the vent plate 32.

The sub-plate 34 faces the vent plate 32, interposing the insulation member 33, and thus is electrically connected to the vent 321. The middle plate 38 is disposed between the insulation member 33 and the sub-plate 34. The vent 321 protrudes through a plurality of through holes of the insulation member 33 and the middle plate 38 and is thus connected to the sub-plate 34.

Therefore, the middle plate 38 is electrically connected to the sub-plate 34 and the vent 321. In addition, the middle plate 38 is connected to a positive electrode lead tab 42 by welding, and the positive electrode lead tab 42 is connected to the uncoated region 133 (referring to FIG. 2A) of the positive electrode 13 by welding. Resultantly, the positive electrode lead tab 42 is electrically connected to the cap plate 31 by sequentially passing through the middle plate 38, the sub-plate 34, the vent 321, the vent plate 32, and the positive temperature coefficient element 35.

The positive electrode insulating plate 62 is disposed between the sub-plate 34 and the electrode assembly 10 to electrically insulate the positive electrode 13 and the positive electrode lead tab 42 from the sub-plate 34 or the middle plate 38. The positive electrode lead tab 42 is connected to the uncoated region 133 of the positive electrode 13 and passes through the positive electrode insulating plate 62 to be connected to the middle plate 38.

The cap assembly 30 is inserted into the opening of the case 20 by providing the gasket 50, and is fixed to the opening of the case 20 through a crimping process to thus form the rechargeable battery cell 110. In this instance, the case 20 provides a beading portion 21 and the gasket 50 inserted in the center of the diameter direction of the case 20 on the side of the opening to form a clamping portion 22 for holding an external circumference of the assembly 30.

The first separator 121 and the second separator 122 form a re-spiral-wound region RW that is re-spiral-wound while enclosing respective first ends 11a and 13a of the negative electrode 11 and the positive electrode 13 in the center side of the electrode assembly 10. At least a portion of the re-spiral-wound region RW is disposed between the negative electrode 11 and the positive electrode 13 in the diameter direction of the electrode assembly 10.

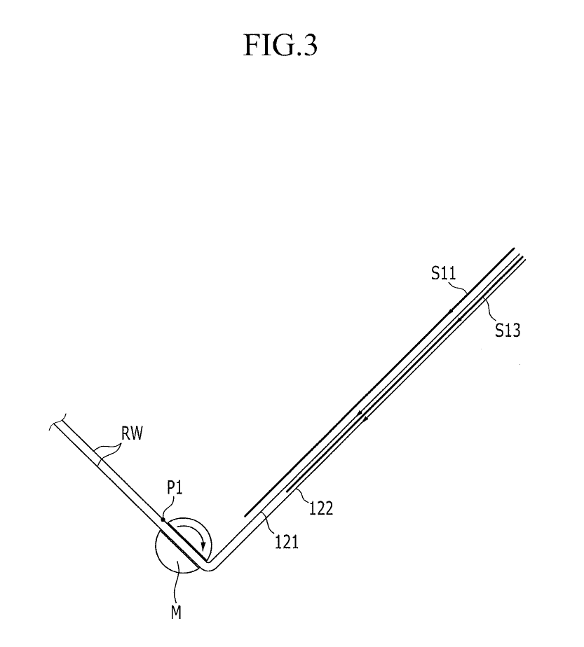

In detail, as illustrated in FIG. 2A, each of a first portion 121a of the first separator 121 and a first portion 122a of the second separator 122 has a predetermined length, and the first portions 121a and 122a are attached to each other along the entire predetermined length without the negative electrode 11 and the positive electrode 13 to define a combined portion RW′ (FIG. 3). The negative electrode 11 and the positive electrode 13 are attached to portions of the first and second separator 121 and 122 that are not within the combined portion RW′. Therefore, as illustrated in FIG. 2B, when the combined portion RW′ is folded once to define the re-spiral-wound region RW (shaded area in FIG. 2B), which is wound around the center pin 14, before wounding the electrodes 11 and 13 and the remainder of the separators 121 and 122 around the center pin 14, the re-spiral-wound region RW separates the center pin 14 from the first end 11a of the negative electrode 11.

The re-spiral-wound region RW has a predetermined range in the spiral-wound direction. Accordingly, the second separator 122 that is spiral-wound with the re-spiral-wound region RW at least a predetermined number of times is triply disposed between the first ends of the positive electrode 13 and the negative electrode 11 that is spiral-wound the predetermined number of times in the diameter direction (referring to A of FIG. 2A).

That is, in the diameter direction, the first separator 121 is disposed between the first end of the positive electrode 13 and the negative electrode 11 inside, and the second separator 122 and re-spiral-wound region RW are disposed between the first end of the positive electrode 13 and the negative electrode 11 that is spiral-wound the predetermine number of times (for example, 1 time).

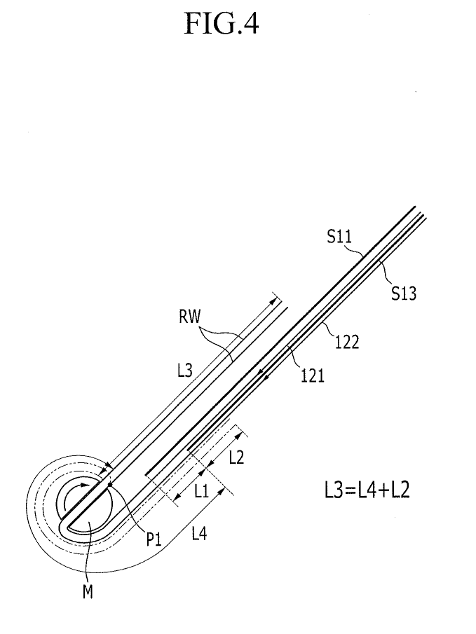

At this time, the end of the negative electrode 11 and the end of the positive electrode 13 maintain a first distance L1 according to the spiral-wound direction, and the end of the positive electrode 13 and the end of the re-spiral-wound region RW maintain a second distance L2 according to the spiral-wound direction. A length L4 indicates a length between the start point P1 of the re-spiral-wound region RW, i.e., a folding point of the combined portion RW′, and an end of the positive electrode 13 attached to the combined portion RW′ in the spiral-wound direction (FIG. 4). A length L3 refers to the entire length of the re-spiral-wound region RW in the spiral-wound direction and is predetermined as to be larger than the length L4, i.e., (L3>L4, L3=L4+L2).

Also, the entire length L3 of the re-spiral-wound region RW may be larger than the spiral-wound length of one time of the negative electrode 11 and may be smaller than the n spiral-wound length of the +1 times of the negative electrode 11. As one example, in FIG. 2A, the entire length L3 of the re-spiral-wound region RW is larger than the one time length of the spiral-wound negative electrode 11 and is smaller than the spiral-wound length of two times of the negative electrode 11.

Accordingly, the first and second separators 121 and 122 and the re-spiral-wound regions RW are quadruply disposed outside at the end of the negative electrode 11, e.g., the folded structure of the first and second separators 121 and 122 may define four layers before the negative electrode 11 is attached and wound around the center pin 14. Also, the second separator 122 and the re-spiral-wound region RW are triply disposed at the end of the positive electrode 13. The re-spiral-wound region RW provides a slip and cushion effect, thereby reducing a pressure applied to the first and second separators 121 and 122.

Accordingly, bending of the negative and the positive electrodes 11 and 13 may be prevented near the end of the positive electrode 13 of the electrode assembly 10. In spite of the thickness of the coating region 132 near the end of the positive electrode 13 and the burr formed at the end of the current collector 131, breakage and damage of the first and second separators 121 and 122 may be prevented and a potential short of the negative and positive electrodes 11 and 13 may be prevented. That is, an inner short, i.e., close to the center pin 14, of the rechargeable battery may be prevented.

Next, a process of manufacturing the electrode assembly 10 will be described. FIG. 3 illustrates a state diagram of an electrode material and a separator supplied to a mandrel manufacturing the electrode assembly of FIG. 1.

Referring to FIG. 3, the mandrel M is driven in a clockwise direction such that the first and second separators 121 and 122 in the combined portion RW′ are additionally supplied through the mandrel M thereby forming the re-spiral-wound region RW. Also, in the electrode assembly 10, a negative electrode material S11 forming the negative electrode 11 is supplied between the first and second separators 121 and 122, and a positive electrode material S13 forming the positive electrode 13 is supplied in one side of the second separator 122.

FIG. 4 illustrates a re-spiral-wound start state diagram of a separator re-spiral-wound region, following FIG. 3. Referring to FIG. 4, in the state of FIG. 3, the mandrel M is further driven in the clockwise direction such that the combined portion RW′ is folded, so the re-spiral-wound region RW overlaps the end of the negative and positive electrode materials S11 and S13.

At this time, the entire length L3 of the re-spiral-wound region RW is predetermined to be larger than the length L4 of the first and second separators 121 and 122 between the start point P1 of the re-spiral-wound region RW and the end of the positive electrode 13, that is, (L3>L4, L3=L4+L2). Accordingly, the re-spiral-wound region RW overlaps the negative electrode material S11 by the length (the sum (L1+L2) of the first and second distances (L1 and L2)) and overlaps the positive electrode material S13 by the length (the second distance L2). At this time, the ends of the negative and the positive electrode materials S11 and S13 are separated by the first distance L1 in the spiral-wound direction.

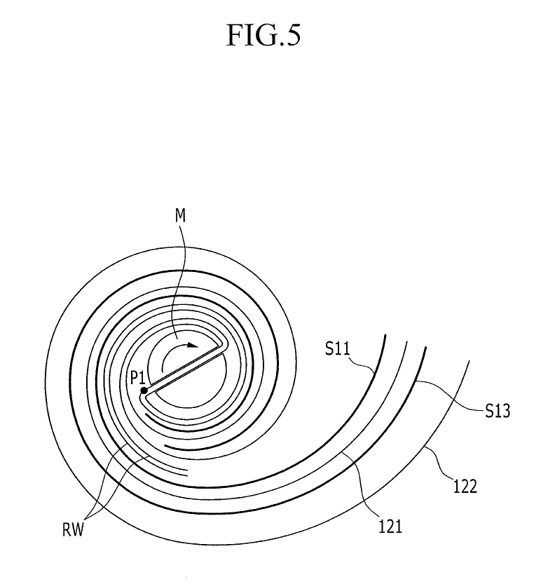

FIG. 5 illustrates a spiral-wound state diagram of a separator re-spiral-wound region, an electrode material, and a separator, following FIG. 4. Referring to FIG. 5, in the state of FIG. 4, the mandrel M is further driven in the clockwise direction such that the re-spiral-wound region RW is spiral-wound along with the first and second separators 121 and 122 and the negative and positive electrode materials S11 and S13.

At this time, the first and second separators 121 and 122 and the re-spiral-wound region RW thereof are quadruply disposed at the end of the negative electrode material S11. Also, the second separator 122 and the re-spiral-wound region RW are triply disposed at the end of the positive electrode material S13. Accordingly, the bending of the negative and the positive electrode materials S11 and S13 may be improved near the end of the electrode positive electrode material S13.

As described above, in an exemplary embodiment, a dual re-spiral-wound region defined only by the first and second separators, i.e., without electrode material, is wound before spiral-winding the first and second electrodes. The dual re-spiral-wound region (the dual separator) is provided between the center and inner edges of the first and second electrodes along a diameter direction. Accordingly, when cutting the first and second electrodes, where the active material is coated on the current collector, damage to the separator may be prevented in spite of the thickness of the coating region and the burr formed at the end of the current collector.

In contrast, when a conventional positive electrode having an uncoated region at a single end of the current collector is spiral-wound, the positive electrode may include the uncoated region at a center and a lead tab is welded to the uncoated region. The conventional separator on the positive electrode may have a thin thickness of about 1/10 of a thickness of the positioned electrode, i.e., the separator may be weak in terms of physical impact.

However, since the uncoated region in the conventional positive electrode is removed in the front end and the end, the front end may be deformed by the thickness of the coating region and the front end may push the separator. Also, when the conventional positive electrode (the current collector and the coating region) is cut, the separator may be damaged by a burr generated at the end of the current collector. Accordingly, in the conventional electrode assembly, the negative electrode and the positive electrode may be shorted.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A rechargeable battery, comprising:
an electrode assembly including spiral-wound a first electrode, a first separator, second electrode, and a second separator, the first electrode, first separator, second electrode, and second separator being sequentially disposed around a center;
a case receiving the electrode assembly; and
a cap assembly coupled to an opening of the case,
wherein the first separator and the second separator enclose first ends of the first electrode and the second electrode at the center, portions of the first and second separators defining a re-spiral-wound region having at least a first portion disposed between the first electrode and the second electrode in a diameter direction of the electrode assembly.

2. The rechargeable battery as claimed in claim 1, wherein the re-spiral-wound region has a predetermined range in a spiral-wound direction.

3. The rechargeable battery as claimed in claim 2, wherein the re-spiral-wound region and the second separator, which is spiral-wound at least a predetermined number of times, are triply disposed between the center and the first ends of the second electrode and the first electrode, which are spiral-wound a predetermined number of times in the diameter direction.

4. The rechargeable battery as claimed in claim 2, wherein:
the first end of the first electrode and the first end of the second electrode maintain a first distance according to the spiral-wound direction, and
the first end of the second electrode and an end of the re-spiral-wound region maintain a second distance according to the spiral-wound direction.

5. The rechargeable battery as claimed in claim 4, wherein an entire length of the re-spiral-wound region is larger than a length of the first separator and the second separator between a start point of the re-spiral-wound region and the first end of the second electrode in the spiral-wound direction.

6. The rechargeable battery as claimed in claim 5, wherein the entire length of the re-spiral-wound region is larger than the length of a predetermined number of spiral-wound times of the first electrode, and is smaller than a length of (n+1) spiral-wound times of the first electrode.

7. The rechargeable battery as claimed in claim 3, wherein:
the first separator is between the first end of the second electrode and the first electrode in the diameter direction, and
the second separator and the re-spiral-wound region are between the first end of the second electrode and the first electrode that is spiral-wound the predetermined number of times.

8. The rechargeable battery as claimed in claim 2, wherein:
the first electrode has an uncoated region at an outermost end thereof, and
the second electrode has an uncoated region between both ends thereof.

9. The rechargeable battery as claimed in claim 8, wherein:
the uncoated region of the first electrode is connected to the case by a first lead tab, and
the uncoated region of the second electrode is connected to the cap assembly by a second lead tab.
